(19) United States
(12) Patent Application Publication
(10) Pub. No.: US 2015/0218043 A1
(43) Pub. Date: Aug. 6, 2015

(54) GLASS MOLDED ARTICLE AND METHOD FOR PRODUCING SAME, OPTICAL ELEMENT BLANK, AND OPTICAL ELEMENT AND METHOD FOR PRODUCING SAME

(71) Applicants: Mikio Ikenishi, Tokyo (JP); Shizuo Suzuki, Tokyo (JP); Natthasit Wongwee, Amphur Muang, Lamphun (TH); Jiraporn Luangjai, Amphur Muang, Lamphun (TH)

(72) Inventors: Mikio Ikenishi, Tokyo (JP); Shizuo Suzuki, Tokyo (JP); Natthasit Wongwee, Amphur Muang (TH); Jiraporn Luangjai, Amphur Muang (TH)

(73) Assignees: HOYA OPTICS(THAILAND) LTD., Amphur Muang, Lamphun (TH); HOYA CORPORATION, Tokyo (JP)

(21) Appl. No.: 14/415,358

(22) PCT Filed: Jul. 11, 2013
(86) PCT No.: PCT/JP2013/068994

§ 371 Date: Jan. 16, 2015

(30) Foreign Application Priority Data
Jul. 18, 2012 (JP) 2012-159453

(51) Int. Cl. C03C 17/22; C03B 23/00

(52) U.S. Cl. CPC C03C 17/22; C03B 23/0013; C03C 2217/28; C03C 2218/11

(57) ABSTRACT

[Problem] When heating a glass gob of glass which crystallizes easily to a temperature at which press-molding is possible, there are many cases in which the surface of the glass gob crystallizes and hardens. The problem of surface crystallization of glass gobs when press-molding is particularly prominent with glass to be polished and subjected to press-molding at a high temperature. [Solution] This method for producing a glass molded article includes a step (A) for covering the surface of a glass gob with a covering agent, and a step (B) for heating, softening and molding the glass gob covered by the covering agent. Therein, the covering agent contains components which melts at a temperature equal to or lower than the melting point of the glass configuring the glass gob.

The present invention relates to a glass molded article and the production method thereof, an optical element blank, and an optical element and the production method thereof.

### DESCRIPTION OF THE RELATED ART

As the method of producing the optical element made of glass such as lens or so, there is a method of forming the optical element having a shape close to the optical element, then grinding and polishing to form the optical element. As the method of producing the glass molded article, for example, the method of preparing the glass gob made of uniform optical glass, then heating said glass gob to soften thereby to produce the glass molded article.

Specifically, in JP Patent Application Laid Open No. 2007-210863 (the patent article 1), the method of producing the optical element blank having the shape close to the shape of the optical element by the press-molding, and processing the optical element blank thereby producing the optical element is described.

### PRIOR ART

### Patent Article

Patent Article 1: JP Patent Application Laid Open No. 2007-210863

### DISCLOSURE OF INVENTION

### Problem to be Solved by the Invention

When heating the glass gob of the glass which easily crystalizes to the temperature possible to press-mold, the surface of the glass gob cures due to the crystallization in many cases. For the high performance optical lens glass such as a high refractive index low dispersion glass or an ultra low dispersion glass or so which were developed recently, a crystallization of the surface of the glass gob during the press-molding is significant.

When the glass gob comprising a cured coating due to the crystallization of the surface, the cured coating is embedded into the inside of the glass gob, thus the obtained glass molded article becomes non-uniform from the surface to the deeper part. The non-uniform glass molded article as such needs to remove the non-uniform part of the cured coating or so which has been embedded, by grinding or polishing or so. As a result, the material waste increases and the production cost increases as well.

Thus, by lowering the temperature of the glass surface, or reducing the high temperature maintaining time, and the heating temperature of the glass gob was lowered thereby suppressing the crystallization of the glass surface.

However, when the heating temperature of the glass gob is lowered and press-molded, cracks may be occurred to the glass, or the temperature distribution in the glass gob becomes large or so thereby it cannot be molded to the desired shape.

Under such situation, the production method of the high quality glass molded article by suppressing the crystallization of the glass surface during the molding without lowering the heat temperature of the glass gob is in demand, and the production method of glass molded article having little waste of the glass material is in demand as well.

### Means for Solving the Problems

The present inventors focused to the difference of free energy between the inside and the surface of the glass gob as the cause of the glass surface being selectively crystalizing when heating and softening the glass gob. That is, the surface of the glass gob has large free energy compared to the inside hence it tends to crystalizes easily. Thus, it is thought that the surface of the glass gob is crystalized preferentially compared to the inside thereof.

Thus, in order to prevent the crystallization on the surface of the glass gob, it was found to coat the glass gob by the coating agent. By coating the glass gob by the coating agent, the surface free energy of the glass gob which easily crystalizes is lowered and the crystallization of the glass gob surface can be suppressed.

Also, as the coating agent, by using the component which does not crystalize at the surface of the glass gob and can maintain the fluid state as the soften glass, it was found that the coating agent itself crystalize cures thus enables to prevent from being embedded into the glass gob.

The present invention provides the glass molded article and the production method of the glass molded article of the glass molded article or so.

[1] A production method of a glass molded article comprising

a step A of coating a surface of glass gob by a coating agent,

a step B of heating, softening and molding said glass gob coated with said coating agent; wherein

said coating agent comprises a component which melts at a temperature equal to or lower than a softening temperature of the glass constituting said glass gob.

[2] The production method of the glass molded article as set forth in [1], wherein in said step B, said glass gob is heated at a temperature so that a viscosity of glass constituting said glass gob is 10⁶ dPa·s or less.

[3] The production method of the glass molded article as set forth in [1] or [2], wherein said coating agent comprises one or more element selected from the group consisting of boron, phosphorus, silicon and bismuth.

[4] The production method of the glass molded article as set forth in any one of [1] to [3], wherein said coating agent comprises one or more component selected from the group consisting of boric acid, borate, boric acid ester, bismuth borate containing glass, zinc borate containing glass, alkali silicate, phosphoric acid and phosphate.

[5] The production method of the glass molded article as set forth in any one of [1] to [4], wherein said coating agent is made from a solution.

[6] The production method of the glass molded article as set forth in any one of [1] to [5], wherein said coating agent is made from an aqueous solution comprising boric acid or phosphoric acid.

[7] The production method of the glass molded article as set forth in any one of [1] to [6], wherein said step B comprises a press-molding step.

[8] A glass molded article obtained by the production method as set forth in any one of [1] to [7].

[9] A glass molded article molded from a glass gob into a predetermined shape, wherein said glass molded article comprises a glass molded article main body and a surface layer formed on a surface of said main body,

said surface layer comprises a component which melts at temperature of equal to or less than a softening temperature of a glass constituting said main body.

[10] A glass molded article as set forth in [9], wherein a content of one or more component selected from the group consisting of boron, phosphorous, silicon and bismuth in said surface layer is larger than a content of said component at an inside of said main body.

[11] The glass molded article as set forth in [9] or [10], wherein said surface layer includes one or more of component selected from the group consisting of boric acid, borate, boric acid ester, bismuth borate containing glass, zinc borate containing glass, alkaline silicate, phosphorous and phosphate.

[12] The glass molded article as set forth in any one of [9] to [11], wherein a thickness of said surface layer is 1 to 100 μm.

[13] An optical element blank made of the glass molded article as set forth in any one of [8] to [12].

[14] An optical element made of the glass molded article as set forth in any one of [8] to [12].

[15] A production method of an optical element comprising a step C of processing the optical blank as set forth in [13].

[16] A production method of the optical element as set forth in [15], wherein said step C includes a step of removing the surface layer of said optical element blank,

In the present invention, “the softening temperature” refers to the temperature at which the viscosity of the glass becomes 10^{7.6} dPa·s, and it is also called “Littleton temperature”. In the present specification, “the softening temperature” refers to the temperature measured by the method in accordance to JIS R 3103-1:2001.

### The Effect of the Invention

By using the production method of the glass molded article of the present invention, the cured layer of the glass surface by the crystallization during the softening can be suppressed, and can prevent the deterioration of the optical uniformity of inside of the glass which is caused by the cured layer entering to the inside of the glass by molding. As a result, by using the present invention, the high quality glass molded article can be produced. Also, by the production method of the glass molded article of the present invention, the waste of the glass material can be made little, and the glass molded article and the optical element can be produced in a low cost.

### BRIEF DESCRIPTION OF DRAWINGS

Hereinafter, the embodiments of the glass molded article of the present invention and the production method thereof will be described.

The production method of the glass molded article of the present invention comprises

a step A of coating a coating agent to a surface of a glass gob, and

a step B of heating, softening and molding said glass gob coated with said coating agent; wherein

said coating agent comprises a component which melts at the temperature equal to or lower than a softening temperature of the glass constituting the glass gob.

### 1 Glass Gob

The glass gob used in the present invention is produced by the known method.

As the first example of the production method of the glass gob, an uniform molten glass is produced by melting, refining and stirring the glass raw material, then the glass block is prepared by casting in the mold, then this glass block is annealed to obtain the glass piece by cutting in a cubic shape, and the glass gob can be produced which have same weight and shape made of each optical glass by carrying out the barrel polishing.

As the second example of the production method of the glass gob, there is the method wherein the glass column having the columnar shape is molded by casting the molten glass in the mold of cylinder shape, and the glass column molded in the mold is drawn out in vertically downward direction at a constant speed from the opening part of the mold bottom part, then the glass column is gradually cooled, then a glass piece having approximate circular shape is obtained by cutting or dividing, and this glass gob is carried out with the polish processing or barrel polishing thereby the glass gob is produced. The drawing speed may be carried out so that the molten glass level in the mold is constant.

As the third example of the production of the glass gob, there is the method wherein the molten glass produced by melting, refining and stirring the glass raw material is drained out, and while the molten glass flow draining out is received by the molding die, the amount of the molten glass gob necessary for the production of the glass molded article is separated and received in the molding die, thereby producing the glass gob. The glass gob produced as such has suitable shape and weight for the press-molding, thus it is possible to carry out the press-molding without the barrel polishing as mentioned in the above method; however it is possible to carry out the press-molding after carrying out the barrel polishing. Also, the molding die which receives the glass is not particularly limited, and it may be a float molding (the mold having a structure wherein the concave part receiving the molten glass is formed of porous materials, and the gas was spurted out from the surface of the concave part via the porous material), or it may a mold having a saucer shape which is simple formed at the receiving part of the concave shape.

The composition of the glass constituting the glass gob used for the glass molded article of the present invention and the production method thereof is not particularly limited; and for example fluorophosphates glass, lanthanum borate containing glass which are useful as the optical glass can be used.

### 2 Step of Coating the Coating Agent to the Surface of the Glass Gob (Step A)

In step A of the present invention, the coating agent comprising the component which melts at the temperature equal to or lower than the softening temperature of the glass constituting the glass is coated on the glass gob.

As the coating agent, the component which melts at the temperature equal to or lower than the softening temperature of the glass constituting the glass is used. Also, the compound used as the coating agent preferably does not easily crystalizes.

As such coating agent, it is not particularly limited as long as it comprises the component which melts at the temperature equal to or lower than the softening temperature of the glass constituting the glass gob; however the coating agent comprising one or more elements selected from the group consisting of boron, phosphorous, silicon and bismuth or so may be mentioned. These components easily form the glass network, thus it can be easily taken into the glass constituting the glass gob, hence it is thought that it would be difficult to crystalize at the surface thereof.

Among these, in case the glass constituting the glass gob is boric acid based glass, it is preferable to use the coating agent comprising boric acid. Also, in case the glass constituting the glass gob is phosphoric acid based glass, and then it is preferable to use the coating agent comprising the phosphorous.

Further, as such coating agent, the compound such as boric acid, borate, boric acid ester, bismuth borate containing glass, zinc borate containing glass, alkali silicate, phosphoric acid and phosphate or so can be used, and the composition comprising at least one of these can be used. As the composition, the combination of the above mentioned compound, or the solution dissolved in the water or organic solvent or so may be mentioned. The embodiment of the coating agent is not limited, and it may be solid or liquid.

In case of using the glass such as the bismuth borate containing glass or zinc borate containing glass or so as the coating agent, it is preferable to process these glasses in to powder form as it becomes easy to adhere on the surface of the glass gob evenly. Such glass powder can be adhered to the glass gob by the method of scattering, spraying and rubbing or so.

As the bismuth borate containing glass, the commercially available glass as the bismuth borate based low melting point glass; and as the zinc borate containing glass, the commercially available glass as zinc borate based low melting point glass can be used. These compounds have a property which is difficult to crystalize even when heated, thus when the melted coating agent is provided to the surface of the glass gob, the crystallization of the glass gob surface can be prevented effectively.

The particle diameter of the coating agent in a powder form is preferably 5 to 100 μm, and more preferably 10 to 50 μm.

In case of using the liquid coating agent, it is preferable to use the solution dissolving the above mentioned compounds. In case of using boric acid, borate, phosphoric acid and phosphate or so to the coating agent, it is preferably used as the aqueous solution of which these compounds are dissolved in the water. In case the coating agent is a solution, preferably the glass gob is immersed in the container with the solution, or the solution is adhered to the glass gob surface by coating the solution by spraying or brushing.

The concentration of the coating agent of the aqueous solution is preferably 1 to 30 wt %, more preferably 1 to 20 wt %. Particularly, in case the coating agent is boric acid aqueous solution, it is preferably 1 to 5 wt %, and more preferably 1 to 3 wt %. Also, in case the coating agent is phosphoric acid aqueous solution, it is preferably 1 to 20 wt %, and more preferably 1 to 10 wt %.

The coating agent is preferably coated to the face where the crystallization is to be suppressed during the heating and softening, and more preferably to the entire surface of the glass gob.

In case the press-molding is used for the molding of the production method of the present invention, the glass gob for one glass molded article is prepared, and the substance which melts at the temperature equal to or lower than the softening temperature of the glass constituting the glass gob is preferably coated to the surface of the glass gob.

Note that, after the coating agent is coated to the surface of the glass gob, the releasing agent of powder form can be further coated so that the glass gob does not fuse to the molding die (for example, “the lower mold 60” and “the upper mold 61” described in the patent article 1) or the glass gob mounting member (for example, “the softening tray 10” described in the patent article 1) where the heated glass gob is placed on. The releasing agent is coated by the known method.

The releasing agent may be used by combining with the coating agent, or it may be coated after the coating agent. As the releasing agent, for example the powder form releasing agent such as boron nitride, alumina, silicon oxide, magnesium oxide or so may be mentioned.

### 3 Step of Heating, Softening and Molding the Glass Gob (Step B)

In the step B of the present invention, the glass gob coated with the coating agent is heated, softened and molded; thereby the glass molded article is obtained.

### (1) The Softening of the Glass Gob

In the step of heating and softening the glass gob, the glass gob coated with the coating agent on the surface is placed on the heat resistant glass gob mounting member, and it can be carried out by introducing the glass gob mounting member into the heating device (for example, “the softening furnace 30” described in the patent article 1). When the glass gob coated with the coating agent is heated, the softened glass gob becomes a softened state, and the coating agent on the surface of the glass gob melts and the surface layer is formed on the surface of the glass gob.

When the surface layer is formed on the surface of the glass gob, the glass which is exposed to the surface is coated with the surface layer, and the crystallization of the glass gob can be suppressed significantly.

The thickness of the surface layer based on the coating agent is not limited, however the thickness which can suppress the crystallization of the surface of the glass gob coated with the coating agent is necessary, and the thickness is preferably 1 to 100 μm, and more preferably 5 to 50 μm.

In order to mold the desired shape without breaking the glass, the heating and the softening of the glass prior to the molding is preferably carried out by the heating at the temperature so that the viscosity of the glass becomes 10⁶ dPa·s or less, and it is more preferable to carry out the heating at the temperature so that the viscosity of the glass becomes 10⁵ dPa·s or less. According to the present invention, the devitirification of the glass surface is suppressed even when the glass is heated and softened to such viscosity.

In case of using boric acid, borate, phosphoric acid, phosphate or so as the coating agent, it is preferable to coat the aqueous solution dissolving these compounds in the water to the glass gob surface. In case the coating agent is liquid such as aqueous solution or so, the glass gob is immersed in the liquid, and the coating agent is coated to the glass gob by using the means of spraying the liquid, or pasting the liquid by brush or so. After the coating, it is preferable to use by drying to the level that the coating agent is still fluidized.

When the aqueous solution dissolving these compounds are coated to the glass gob as the coating agent, and heated, then the contained water and the bound water in the coating agent is removed, and the solvent such as the boric acid or so melts at the temperature equal to or lower than the softening temperature of the glass. For example, when the boric acid aqueous solution is coated to the glass gob as the coating agent and heated, the boric acid in the coating agent undergoes dehydration condensation on the surface of the glass gob and melts.

Also, in case the bismuth borate containing glass and zinc borate containing glass is coated to the glass as the coating agent, it is preferable to coat the glass powder which is processed into a powder form to the glass gob surface. In case the coating agent is a powder, the coating agent can be coated to the glass by using the method of passing through the glass gob in the powder, or sprinkling, spraying and rubbing or so the powder over the glass gob. In order for the glass powder to adhere to the glass gob, the component facilitating the adherence to the surface of the glass gob may be added.

When the glass gob coated with the glass powder is heated, the glass powder is softened on the surface of the glass gob and melts.

As such, by coating the coating agent which melts at the temperature equal to or lower than the softening temperature of the glass constituting the glass gob before heating the glass gob, the glass which is supposedly exposed to the surface is coated with the surface layer, thus the crystallization of the glass gob surface generated during the heating of the glass gob can be significantly suppressed. As a result, the cured layer is prevented from entering to the inside of the glass by the heat during the molding, thus the optical uniformity inside the glass can be maintained. Also, by using the present invention, the glass material can be used effectively, and the production yield of the glass molded article will improve.

### (2) Molding

The method of molding the soften glass is not particularly limited, and known methods such as a press-molding method, a rolling method of molding the glass into a rod shape by placing the glass gob between plurality of rotating rollers, and a stretching method or so can be used.

In case of using the press-molding method, the glass gob is heated for softening, and the softened glass is applied with the pressure by press-mold die inside the press molding device, thereby it is molded into a desired shape.

As the press-molding device used for the press-molding method, the known ones can be used. For example, as the press-molding device, those comprising the molding die with the upper mold, the lower mold or body mold if needed, and the pressure applying system to apply the pressure to the upper mold and the lower mold can be mentioned. As the number of the molds, it may be set according to the number of the glass gob supplied at the same time as the glass gob mounting member. When supplying the glass gob to the molding die, the upper mold is moved to the upper side, and while under this condition, the glass gob is supplied on the lower mold. When the supply of the glass mold onto the lower mold is completed, the upper mold is lowered, and the mold is closed, then the softened glass gob is pressed by the upper and the lower mold. Then, the glass is transferred to the molding face of the upper and the lower molds (including the ease of using the body mold and transferring the glass to the inner face of the body mold), then the glass molded article having the desired shape can be obtained.

Next, the glass molded article is taken out from the press-molding die by releasing, and the annealing treatment is carried out. By this annealing treatment, the strain inside the glass is reduced, and the optical characteristic such as refractive index or so can be a desired value.

As the heating condition of the glass gob, the molding condition and the material used for the press-molding die, those already known can be used. The above mentioned steps are carried out in the air.

The obtained glass molded article can be mainly used suitably as the optical element blank. The optical element blank is a glass blank having the shape close to the shape of the optical element of the object, and by grinding and polishing this, the optical element can be produced at the end.

Also, by carrying out the above mentioned press-molding method in high accuracy (the precision press-molding method), the glass molded article which can be used for the optical element can be obtained. In this case, the optical element can be obtained without the polish processing to the glass molded article, hence the production efficiency is high, and also the material loss due to the processing is little. Note that, in case of producing the glass molded article by the precision press-molding method, among the production method of the glass gob discussed in above, the glass gob (preform) obtained by the float molding as described in the third example is preferably used.

### 4 The Glass Molded Article

The glass molded article of the present embodiment is the glass molded article molding the glass gob to a predetermined shape, comprising the glass molded article main body part and the surface layer formed at the surface of the main body part, and

The surface layer comprises the components which melts at the temperature equal to or lower than the softening temperature of the glass constituting the main body part.

In this glass molded article, the surface layer comprises the components which melt at the temperature equal to or lower than the softening temperature of the glass constituting the main body part, thus surface is difficult to be crystalized during the molding, and the deterioration of uniformity due to the cured coating can be suppressed,

Also, this glass molded article has larger content of the component selected from the group consisting of boron, phosphorous, silicon and bismuth in the surface layer than the content of said component at the inside of the main body part. Here, “the inside” is the inside in the thickness direction of the glass molded article (the deeper part of the glass molded article main body part), and the part present further inner side than the surface layer of the glass molded article.

Also, this glass molded article preferably comprises in the surface layer the components selected from the group consisting of boric acid, borate, boric acid ester, bismuth borate containing glass, zinc borate containing glass, alkali silicate, phosphoric acid and phosphorous.

According to such glass molded article, when producing the glass product having high uniformity such as optical element or so, the removed amount of the surface of the glass molded article can be reduced, thus the material waste and the production cost can be reduced. Also, in case the entire glass molded article is uniform, the glass molded article can be used as the optical element.

The glass molded article of the present embodiment can be produced by the production method of the glass molded article of the above.

The thickness of the surface layer of the glass molded article is preferably 1 μm or more from the point of suppressing the crystallization of the surface. On the other hand, from the point of reducing the removed amount when processing the glass molded article, the thickness of the above mentioned surface layer is preferably 100 μm or less. The more preferable lower limit of the thickness of the surface layer is 5 μm, and more preferable upper limit is 50 μm.

For the glass molded article of the present embodiment, the inner part is uniform, and the crystallization of the surface is suppressed, thus it is suited for the optical element or the optical blank.

### 5 The Step of Processing the Optical Element Blank (Step C)

The glass molded article obtained through the step A and the step B can be further processed by the known processing method such as the grinding or polishing. Here, the glass molded article is the optical element blank.

The shape of the glass molded article is molded close to the optical element, and further by carrying out the grinding and/or the polishing, the optical element such as lens and prism or so can be produced.

The method of grinding and/or polishing can be for example carried out by going through the following steps.

(i) The Grinding Step

The glass molded article is ground by using the diamond grind stone so that the shape becomes close to the shape of the optical element of the object.

(ii) The Polishing Step

The face ground in the above mentioned grinding step is polished using the loose grain such as cerium oxide or so.

(iii) The Finishing Polish Step

The polished face is finishing polished using zirconia.

By carrying out such steps, the glass molded article is processed, and the optical element can be produced.

During the processing of the step C, the surface layer of the glass molded article is removed by polishing or grinding, and the uniform glass molded article based on the glass gob is preferably obtained.

Note that, in the production method of the glass molded article of the present invention, the step C is not the essential step, and for example the glass molded article molded in the step B can be used as the optical element.

According to the present invention, the glass molded article can be produced in a good productivity, and further by using the glass molded article, the optical element such as lens and prism or so can be produced stably.

### 6 The Optical Element

As the optical element obtained by processing the glass molded article of the present invention, various lens such as spherical lens, aspherical lens, micro lens or so, diffraction gratings, lens with the diffraction gratings, lens array, prism or so can be mentioned. As from the aspect of the usage, the lens constituting the image optical system such as digital still camera, digital video camera, a single lens reflex camera, mobile phone mounted camera, automobile mounted camera or so; or the lens constituting the optical system for carrying out the data writing to the optical disk such as DVD or CD can be mentioned.

Depending on the needs, the optical thin film can be provided such as the anti-reflection film, total reflection film, partial reflection film, or the film having the spectral characteristics or so.

Hereinabove, the present invention was described based on the embodiment of the present invention, however the present invention is not to be limited thereto, and obviously various embodiments can be carried out within the range which does not exceed the scope of the present invention.

### EXAMPLE

The present invention will be described further specifically based on the examples. However, the present invention is not to be limited thereto.

### Examples 1 to 12, Comparative Example 1 to 5

### The Production of the Glass Molded Article

(1) The Production of the Glass Gob

In order to produce the five types of the optical glasses (the optical glasses 1 to 5) comprising the characteristics shown in Table 1, the glass raw materials were prepared, then each glass raw material were melted, refined and stirred to produce the uniform molten glass, and it was drained out from the draining pipe. While the tip part of the molten glass flow of being drained out is received by the molding die, the necessary amount of the molten glass gob for producing the glass molded article was separated and received on the molding die. The gas was spouted from the molding die, and the gas pressure of upward direction was applied to the molten glass gob on the molding die, then it was molded into a glass gob while floating. As such, the glass gobs of the optical glasses 1 to 5 of five types were produced.

The softening point of the glass was measured by the method in accordance with JIS R 3103-1: 2001.

TABLE 1

| | | Refractive | Abbe | Softening |
|---|---|---|---|---|
| | | index | number | temperature |
| | | (nd) | (vd) | (° C.) |
| Optical glass 1 | Fluorophosphates | 1.593 | 68.6 | 611 |
| | glass | | | |
| Optical glass 2 | lanthanum borate | 1.773 | 49.6 | 690 |
| | containing glass | | | |
| Optical glass 3 | lanthanum borate | 1.729 | 54.7 | 707 |
| | containing glass | | | |
| Optical glass 4 | Fluorophosphates | 1.497 | 81.6 | 490 |
| | glass | | | |
| Optical glass 5 | Fluorophosphates | 1.437 | 95.1 | 444 |
| | glass | | | |

### (2) The Production of the Glass Molded Article

Each glass gob of the optical glasses 1 to 5 was immersed in the aqueous solution (the coating agent) shown in Table 2, and the surface of the glass gob was coated with the coating agent.

Using the optical glasses 1 to 5, each glass gob of which the surface is coated with the coating agent was placed on the softening tray of the glass gob mounting member, and then by placing in the softening furnace, the glass gob was heated and softened (examples 1 to 12). The temperature of the softening furnace was 100° C. higher than the softening temperature of the glass gob, and the time that the glass gob was maintained in the softening gob was 10 minutes.

Once each glass gob is softened, the glass gob was taken out from the softening furnace. The coating agent used in each example melts at the temperature equal to or lowers than the softening temperature of the glass gob (Table 2). Therefore, at the surface of the glass gob of the examples 1 to 12 heated in the softening furnace, the melted coating agent was formed so that it covers the surface of the softened glass gob.

TABLE 2

| | | Coating agent | | | |
|---|---|---|---|---|---|
| | | | Melting temperature | | |
| | | | (° C.) | Heating temperature | |
| | Glass used for the | | The temperature which | during molding | Surface of the glass |
| | glass gob | Name | becomes molten glass | (° C.) | molded article |
| Example 1 | Optical glass 1 | Boric acid aqueous | 400 | 711 | Not devitrified |
| | | solution (4 wt %) | | | (no crystalization) |
| Example 2 | Optical glass 2 | Boric acid aqueous | 400 | 790 | Not devitrified |
| | | solution (4 wt %) | | | (no crystalization) |
| Example 3 | Optical glass 3 | Boric acid aqueous | 400 | 807 | Not devitrified |
| | | solution (4 wt %) | | | (no crystalization) |
| Example 4 | Optical glass 1 | Boric acid aqueous | 400 | 711 | Not devitrified |
| | | solution (2 wt %) | | | (no crystalization) |
| Example 5 | Optical glass 2 | Boric acid aqueous | 400 | 790 | Not devitrified |
| | | solution (2 wt %) | | | (no crystalization) |
| Example 6 | Optical glass 3 | Boric acid aqueous | 400 | 807 | Not devitrified |
| | | solution (2 wt %) | | | (no crystalization) |
| Example 7 | Optical glass 4 | Phosphoric acid aqueous | 200 | 590 | Not devitrified |
| | | solution (18 wt %) | | | (no crystalization) |
| Example 8 | Optical glass 5 | Phosphoric acid aqueous | 200 | 544 | Not devitrified |
| | | solution (18 wt %) | | | (no crystalization) |
| Example 9 | Optical glass 4 | Phosphoric acid aqueous | 200 | 590 | Not devitrified |
| | | solution (9 wt %) | | | (no crystalization) |
| Example 10 | Optical glass 5 | Phosphoric acid aqueous | 200 | 544 | Not devitrified |
| | | solution (9 wt %) | | | (no crystalization) |
| Example 11 | Optical glass 4 | Phosphoric acid aqueous | 200 | 590 | Not devitrified |
| | | solution (5 wt %) | | | (no crystalization) |
| Example 12 | Optical glass 5 | Phosphoric acid aqueous | 200 | 544 | Not devitrified |
| | | solution (5 wt %) | | | (no crystalization) |
| Comparative | Optical glass 1 | None | — | 711 | Devitrified (crystalized) |
| example 1 | | | | | |
| Comparative | Optical glass 2 | None | — | 790 | Devitrified (crystalized) |
| example 2 | | | | | |
| Comparative | Optical glass 3 | None | — | 807 | Devitrified (crystalized) |
| example 3 | | | | | |
| Comparative | Optical glass 4 | None | — | 590 | Devitrified (crystalized) |
| example 4 | | | | | |
| Comparative | Optical glass 5 | None | — | 544 | Devitrified (crystalized) |
| example 5 | | | | | |

Next, the glass gob on the softening tray was introduced in to the press-molding die for press-mold. The molding face of the press-molding die has a shape wherein the surface of the glass molded article (the optical element blank) to be obtained is reversed. Note that, the heating temperature during the molding are as shown in Table 2.

Then, the glass molded article (the optical element blank) obtained by press-molding as such was taken out from the molding die. When the surface of the glass molded article was observed, the surface of the glass molded article of the examples 1 to 12 were not crystalized, and the cured coating due to the crystallization was not formed. Also, the cured coating was not embedded into the inside of the glass molded article as well. Further, the glass molded article of the examples 1 to 12 did not devitrify.

Note that, in the examples 1 to 12, boron nitride powder was coated together with the aqueous solution (the coating agent) shown in Table 2 to the surface of the glass gob, the glass gob was heated, softened and press-molded as same as the examples 1 to 12, thereby the glass molded article was produced. For the glass molded article produced as such, no crystallization was formed on any of the surface, and cured coating due to the crystallization was not formed as well. Also, the cured coating was not embedded into the inside of the glass molded article. Also, the inside of each glass molded article did not devitrify.

On the other hand, in the comparative examples 1 to 5, except for not using the coating agent, the glass molded article (the optical element blank) was produced by each glass gob of the optical glasses 1 to 5 under the same condition as the examples 1 to 12.

For the glass molded article of the comparative examples 1 to 5 wherein the glass gob was not coated with the coating agent were also observed for the surface of the obtained glass molded article as similar to the examples to 1 to 12, however the crystallization was formed on the surface of the glass molded article, and the cured coating was formed. Also, the glass molded articles obtained from the comparative examples 1 to 5 were devitrified.

### Examples 13 to 24

### The Production of the Spherical Lens

The glass molded article (the lens blank) of the example 1 was annealed so that the optical characteristic matches with the optical characteristic of the object lens, and also the strain in the glass was reduced. Then, by the known methods, the lens blank was ground and polished for processing, and the spherical lens was produced (example 13).

As similar to the example 13, each spherical lens of the examples 14 to 24 were produced from each glass molded article (the optical element blank) of examples 2 to 12.

The spherical lenses were produced in the examples 13 to 24, however other optical element such as prims can be produced from the glass molded article of the examples 1 to 12.

Finally, the embodiment of the present invention will be summarized.

[1] A production method of a glass molded article of the present embodiment comprises

a step A of coating a surface of glass gob by a coating agent,

a step B of heating, softening and molding said glass gob coated with said coating agent; wherein

said coating agent comprises a component which melts at a temperature equal to or lower than a softening temperature of the glass constituting said glass gob.

[2] Preferably, in the production method of the glass molded article as set forth in above [1], in said step B, said glass gob is heated at a temperature so that a viscosity of glass constituting said glass gob is 10⁶ dPa·s or less.

[3] Preferably, in the production method of the glass molded article as set forth in above [1] or [2], said coating agent comprises one or more element selected from the group consisting of boron, phosphorus, silicon and bismuth.

[4] Preferably, in the production method of the glass molded article as set forth in any one of above [1] to [3], said coating agent comprises one or more component selected from the group consisting of boric acid, borate, boric acid ester, bismuth borate containing glass, zinc borate containing glass, alkali silicate, phosphoric acid and phosphate.

[5] Preferably, in the production method of the glass molded article as set forth in any one of above [1] to [4], said coating agent is made from a solution.

[6] Preferably, in the production method of the glass molded article as set forth in any one of above [1] to [5], said coating agent is made from an aqueous solution comprising boric acid or phosphoric acid.

[7] Preferably, in the production method of the glass molded article as set forth in any one of above [1] to [6], said step B comprises a press-molding step.

[8] Preferably, a glass molded article is obtained by the production method of the glass molded article as set forth in any one of above [1] to [7].

[9] Preferably, in other aspect, the glass molded article of the present embodiment is a glass molded article of which a glass gob is molded into a predetermined shape, wherein said glass molded article comprises a glass molded article main body and a surface layer formed on a surface of said main body, and

said surface layer comprises a component which melts at temperature of equal to or less than a softening temperature of a glass constituting said main body.

[10] Preferably in the glass molded article as set forth in above [9], a content of one or more component selected from the group consisting of boron, phosphorous, silicon and bismuth in said surface layer is larger than a content of said components at an inside of said main body.

[11] Preferably, in the glass molded article as set forth in above [9] or [10], said surface layer comprises one or more of component selected from the group consisting of boric acid, borate, boric acid ester, bismuth borate containing glass, zinc borate containing glass, alkaline silicate, phosphorous and phosphate.

[12] Preferably, in the glass molded article as set forth in any one of [9] to [11], a thickness of said surface layer is 1 to 100 μm.

[13] In other aspect, an optical element blank is made of the glass molded article as set forth in any one of [8] to [12].

[14] In other aspect, an optical element of the present embodiment is made of the glass molded article as set forth in any one of [8] to [12].

[15] In other aspect, in the production method of an optical element of the present embodiment comprises a step C of processing the optical blank as set forth in [13].

[16] Preferably, in the production method of the optical element as set forth in above [15], the step C comprises the step of removing the surface layer of said optical element blank.

Further, for other aspect of the present embodiment,

[A1] The production method of the glass molded article of the present embodiment comprises a step A of coating the surface of the glass gob with the coating agent which melts at the temperature equal to or lower than the softening temperature of the glass constituting the glass gob, and

a step B of heating, softening and molding the glass gob coated with the coating agent.

[A2] Preferably, in the production method of the glass molded article as set forth in above [A1], in step B, said glass gob is heated at a temperature so that a viscosity of glass constituting said glass gob is 10⁶ dPa·s or less.

[A3] Preferably, in the production method of the glass molded article as set forth in above [A1] or [A2], said coating agent comprises one or more component selected from the group consisting of boric acid, borate, boric acid ester, bismuth borate containing glass, zinc borate containing glass, alkali silicate, phosphoric acid and phosphate.

[A4] Preferably, in the production method of the glass molded article as set forth in above [A1] or [A2], said coating agent is made from an aqueous solution comprising boric acid or phosphoric acid.

[A5] Preferably, in the production method of the glass molded article as set forth in any one of above [A1] to [A4], the molding of the step B is a press-molding.

[A6] Preferably, in the production method as set forth in above [A3], the glass molded article comprises a glass gob and the surface layer formed thereon, and

said surface layer comprises one or more component selected from the group consisting of boric acid, borate, boric acid ester, bismuth borate containing glass, zinc borate containing glass, alkali silicate, phosphoric acid and phosphate.

[A7] Preferably, the production method of the glass molded article of the present embodiment comprises a step C of processing the glass molded article obtained by the production method of the glass molded article as set forth in any one of above [A1] to [A6].

[A8] Preferably, the production method of the glass molded article of the present embodiment comprises a step C of removing the surface layer by processing the glass molded article obtained by the production method of the glass molded article as set forth in above [A6].

[A9] Preferably, in the production method of the glass molded article as set forth in any one of above [A1] to [A8], the glass molded article is the optical element or the optical element blank.

[A10] In other aspect, the glass molded article of the present embodiment is the glass molded article comprising the glass gob and the surface layer formed on the surface thereof, and said surface layer is made of the components which melts at a temperature equal to or lower than a softening temperature of the glass constituting said glass gob.

[A11] Preferably, in the glass molded article as set forth in above [A10], said surface layer comprises one or more component selected from the group consisting of boric acid, borate, boric acid ester, bismuth borate containing glass, zinc borate containing glass, alkali silicate, phosphoric acid and phosphate.

[A12] Preferably, in the glass molded article as set forth above [A10] or [A11], a thickness of said surface layer is 1 to 100 μm.

[A13] Preferably, in the glass molded article as set forth in any one of above [A10] to [A12], the glass molded article is the optical element or the optical element blank.

### INDUSTRICAL APPLICABILITY

The glass molded article of the present invention can be used as the optical element such as lens or prism or so.

1. A production method of a glass molded article comprising
a step A of coating a surface of glass gob by a coating agent,
a step B of heating, softening and molding said glass gob coated with said coating agent; wherein
said coating agent comprises a component which melts at a temperature equal to or lower than a softening temperature of the glass constituting said glass gob.

2. The production method of the glass molded article as set forth in claim 1, wherein in said step B, said glass gob is heated at a temperature so that a viscosity of glass constituting said glass gob is 106 dPa·s or less.

3. The production method of the glass molded article as set forth in claim 1, wherein said coating agent comprises one or more element selected from the group consisting of boron, phosphorus, silicon and bismuth.

4. The production method of the glass molded article as set forth in claim 1, wherein said coating agent comprises one or more component selected from the group consisting of boric acid, borate, boric acid ester, bismuth borate containing glass, zinc borate containing glass, alkali silicate, phosphoric acid and phosphate.

5. The production method of the glass molded article as set forth in claim 1, wherein said coating agent is made from a solution.

6. The production method of the glass molded article as set forth in claim 1, wherein said coating agent is made from an aqueous solution comprising boric acid or phosphoric acid.

7. The production method of the glass molded article as set forth in claim 1, wherein said step B comprises a press-molding step.

8. A glass molded article obtained by the production method as set forth in claim 1.

9. A glass molded article molded from a glass gob into a predetermined shape, wherein said glass molded article comprises a glass molded article main body and a surface layer formed on a surface of said main body,
said surface layer comprises a component which melts at temperature of equal to or less than a softening temperature of a glass constituting said main body.

10. A glass molded article as set forth in claim 9, wherein a content of one or more component selected from the group consisting of boron, phosphorous, silicon and bismuth in said surface layer is larger than a content of said component at an inside of said main body.

11. The glass molded article as set forth in claim 9, wherein said surface layer includes one or more of component selected from the group consisting of boric acid, borate, boric acid ester, bismuth borate containing glass, zinc borate containing glass, alkaline silicate, phosphorous and phosphate.

12. The glass molded article as set forth in claim 9, wherein a thickness of said surface layer is 1 to 100 μm.

13. An optical element blank made of the glass molded article as set forth in claim 8.

14. An optical element made of the glass molded article as set forth in claim 8.

15. A production method of an optical element comprising a step C of processing the optical blank as set forth in claim 13.

16. A production method of the optical element as set forth in claim 15, wherein said step C includes a step of removing the surface layer of said optical element blank.
